(19) United States
(12) Patent Application Publication
(10) Pub. No.: US 2006/0188702 A1
(43) Pub. Date: Aug. 24, 2006

(54) Electronic apparatus including printed circuit board

(75) Inventor: Toshio Ishimoto, Echizen-shi (JP)

Correspondence Address: REED SMITH LLP, Suite 1400, 3110 Fairview Park Drive, Falls Church, VA, 22042, US

(73) Assignee: Orion Electric Company Ltd.

(21) Appl. No.: 11/354,132

(22) Filed: Feb. 15, 2006

(30) Foreign Application Priority Data
Feb. 22, 2005 (JP) 2005-046275

(51) Int. Cl. B32B 3/00

(52) U.S. Cl. 428/209

(57) ABSTRACT

A copper foil pattern is formed such that mountain portions and valley portions thereof are continuous to be substantially orthogonal to a forward direction of a printed circuit board at the time of solder immersion, and a non-copper foil pattern portion free of a copper foil is provided to be opposed to this copper foil pattern, whereby a peak of the mountain portion is cooled quickly. Thus, a temperature gradient is generated, and a heat is transferred at the time of solder immersion. With this heat transfer, outgases are guided to the peak of the mountain portion, and the guided outgases are easily discharged from a non-copper foil pattern portion in the vicinity of this peak.

### BACKGROUND OF THE INVENTION

1. Field of the Invention

The present invention relates to an electronic apparatus including a printed circuit board which configures an electric circuit by mounting electronic parts and soldering and fixing the electronic parts with molten solder.

2. Description of the Related Art

Conventionally, a “method for soldering a printed circuit board” disclosed in Japanese Patent Application Laid-open No. 10-145035 has been known as a molten solder immersion technique for soldering and fixing a printed circuit board on which electronic parts has been mounted in contact with an ejecting molten solder. According to this conventional technique, there is proposed a method in which a flow of molten solder from an ejection type solder vessel is limited to a forward side nozzle plate direction, molten solder is risen with a surface tension of the molten solder at a site of a backward side nozzle plate, and a printed circuit board is released from the risen site of the molten solder, thereby making it possible to deposit a large amount of solder.

In addition, in a printed circuit board using a double-sided copper-clad laminate substrate as a base, a printed circuit board manufacturing method in which a via hole of a through hole is formed in order to electrically connect a copper foil pattern formed both sides thereof, and the formed via hole is filled with a copper paste includes a “printed wiring board and a method for manufacturing the printed wiring board” disclosed in Japanese Patent Application Laid-open No. 2001-7469. According to this conventional technique, there is proposed a method for preventing a burst or a void phenomenon of a copper paste generated in a via hole by forming a through hole in the vicinity of the via hole.

In the conventional technique described previously, for example, in Japanese Patent Application Laid-open No. 10-145035, conventionally, there has been an excellent soldering technique for depositing a large amount of solder by an automatic soldering apparatus which has been considered to be difficult. However, a heat of molten solder is accumulated more easily at the rear side of a printed circuit board in a backward direction than at the front side of the printed circuit board in a forward direction at the time of solder immersion, resulting in a high temperature. In addition, if a paper substrate such as inexpensive paper phenol is used as a substrate configuring this printed circuit board in order to reduce a material cost, alcohol or the like such as methanol or 1-buthanol included in the paper phenol substrate, and a volatile component such as formaldehyde, toluene and phenol, or a moisture contained in paper material are heated at the time of solder immersion, resulting in a high temperature, and outgases are generated. These outgases are generally discharged in air from terminal holes for inserting terminals of electric parts or a non-copper foil pattern portion at which a paper phenol substrate is exposed without a copper foil pattern being formed. However, as shown in FIG. 14, in the vicinity of a pasted copper foil portion 22a formed to cover a relatively wide range of a surface of a printed circuit board 20, there has been a problem that the discharge of outgas is inhibited by a copper foil 22, and thus, the sealed outgases gather on an interface between a substrate base 21 and the copper foil 22, the copper foil 22 is pushed up, and a swell portion 22b of the copper foil 22 is formed; or alternatively, the substrate base 21 beneath the copper foil 22 swells, and a swell portion 21a of the substrate is formed. If the pasted copper foil portion 22a is allocated at the rear side of the printed circuit board 20 at the time of solder immersion, the swelling of the printed circuit board 20 due to these outgases is prone to frequently occur. In addition, in the vicinity of a terminal hole 26 for inserting a terminal 16 of electronic parts 15 as well, there has been a problem that the swell portion 22b of the copper foil 22 is prone to occur on the printed circuit board 20 due to a thermal load supplied by a heat with a high temperature from the terminal 16 fixed with solder 17 to the printed circuit board 20 and due to a load or the like biased in a spreading direction due to rigidity of the terminal 16.

In addition, in Japanese Patent Application Laid-open No. 2001-7469, in consideration of the fact that outgases are intensively easily discharged from a cross section of a via hole for connecting a copper foil formed on both sides of the printed circuit board, resulting in a swell of a copper paste in the via hole, and thus a burst or a void phenomenon is prone to occur in the copper paste, a through hole is formed for discharging outgases in the vicinity of the via hole. In addition, outgases are generated from the copper paste charged in the via hole as well, and a burst or a void phenomenon occurs in the copper paste. Thus, in order to discharge these outgases, a non-copper foil pattern portion is formed at the periphery of the via hole. These counter measures against outgases are taken for the copper paste charged in a small via hole of about 0.6 mm in diameter for connecting the copper foil pattern formed on both sides of the printed circuit board using a double-sided copper-clad laminate substrate as a base. Therefore, these counter measures are essentially different from a method for preventing the swelling of a printed circuit board due to outgas. In addition, advantageous effect of preventing the swelling, due to outgases, of a pasted copper foil portion which comparatively widely covers a surface of a one-sided printed circuit board or double-sided printed circuit board, cannot be expected. The present invention has been made to solve the above described problems in the conventional technique. It is an object of the present invention to provide an electronic apparatus including a printed circuit board capable of improving long-term reliability of the electronic apparatus by preventing in advance a quality problem that, when the printed circuit board having electronic parts mounted thereon is soldered in accordance with the molten solder immersion technique, a heat of molten solder is easily accumulated at the rear side of the printed circuit board, resulting in a high temperature, and thus, there occurs a swell in copper foil in the vicinity of the terminal hole into which the terminal of electric parts has been inserted, or alternatively, a swell occurs on a copper foil or a substrate base of the printed circuit board due to outgases, and thus the copper foil is peeled off and breakage with an elapse of time occurs.

### SUMMARY OF THE INVENTION

According to a first aspect of the present invention, there is provided an electronic apparatus including a printed circuit board which forms an electric circuit by soldering electronic parts in accordance with a molten solder immersion technique, wherein the printed circuit board consists of a paper-substrate phenol resin copper-clad laminate, a copper foil pattern whose mountain portions and valley portions are continuous is formed and allocated in a predetermined location on the printed circuit board so as to be substantially orthogonal to a forward direction at the time of solder immersion thereof, and a non-copper foil pattern portion is provided to be opposed to the copper foil pattern.

According to the configuration of the first aspect, on a printed circuit board provided in this electronic apparatus, an electric circuit is formed by soldering electronic parts in accordance with molten solder immersion technique. This printed circuit board is formed of a paper-substrate phenol resin copper-clad laminate on which a high temperature occurs due to a heat generated at the time of solder immersion, and outgases including alcohol or the like such as methanol or 1-buthanol contained in a phenol resin and volatile components such as formaldehyde or toluene and phenol or a moisture contained in paper substrate are prone to be generated. In addition, a copper foil pattern whose mountain portions and valley portions are continuous is formed and allocated in a predetermined location so as to be substantially orthogonal to a forward direction of the printed circuit board at the time of solder immersion, and a non-copper foil pattern portion free of a copper foil pattern is provided to be opposed to this copper foil pattern. In this manner, a peak of the copper foil pattern is cooled quickly, and thus, a temperature gradient toward the peak is generated, and a heat generated at the time of solder immersion is transferred. With this heat transfer, the outgases generated from the printed circuit board using the paper substrate and phenol resin as a base is introduced to the peak of the mountain portion, and the introduced outgases are discharged from the non-copper foil pattern portion in the vicinity of this peak.

According to a second aspect of the present invention, in the electronic apparatus including a printed circuit board of the first aspect, a non-resist portion is provided in the vicinity of a peak of the mountain portion.

According to the configuration of the second aspect, there is provided a non-resist portion formed of a heat resistance resin coated film in the vicinity of a peak of the mountain portion formed and allocated on this printed circuit board, from which a resist film for reducing heat radiation is removed by providing heat insulating property, wherein this non-resist portion is soldered in accordance with solder immersion of the printed circuit board.

According to a third aspect of the present invention, in the electronic apparatus including a printed circuit board of the first or second aspect, a through hole is provided at the peak of the mountain portion.

According to the configuration of the third aspect, a through hole for discharging the outgases from a depth portion of a substrate base of the printed circuit board is provided at the peak of the mountain portion formed and allocated on this printed circuit board.

According to a fourth aspect of the present invention, in the electronic apparatus including a printed circuit board of the first or second aspect, the non-copper foil pattern portion is a penetrating portion.

According to the configuration of the fourth aspect, a non-copper foil pattern portion opposed to the copper foil pattern formed and allocated on this printed circuit board is provided as a penetrating portion capable of widely allocating an end area of the through hole for discharging the outgases from the depth portion of the substrate base of the printed circuit board.

According to a fifth aspect of the present invention, in the electronic apparatus including a printed circuit board of any of the first to fourth aspects, the copper foil pattern is allocated in a predetermined location at a rear side of a printed circuit board in a forward direction at the time of solder immersion and a non-copper foil pattern portion is formed behind the copper foil pattern in the forward direction to be opposed to the copper foil pattern.

According to the configuration of the fifth aspect, the copper foil pattern formed and allocated on this printed circuit board is allocated in a predetermined location in which heat with a high temperature due to molten solder is prone to be accumulated, the predetermined location being at the rear side of the printed circuit board in a forward direction at the time of solder immersion resulting in a high temperature. Further, a non-copper foil pattern portion is formed behind a copper foil pattern in the forward direction to be opposed to the copper foil pattern. In this manner, high radiation and cooling are efficiently achieved from the vicinity of the peak of the mountain portion. In addition, heat transfer occurs due to a temperature gradient generated toward the peak of the mountain portion. With this heat transfer, the outgases generated from the printed circuit board using the paper substrate and phenol resin as a substrate base are introduced to the peak of the mountain portion, and are efficiently discharged from the non-copper foil pattern portion, the through hole or the penetrating portion in the vicinity of this peak.

According to the first aspect of the present invention, on a printed circuit board provided in this electronic apparatus, when electrical parts are soldered in accordance with a molten solder immersion technique, a copper foil pattern whose mountain portions and valley portions are continuous to be substantially orthogonal to a forward direction of the printed circuit board at the time of solder immersion is formed and allocated in a predetermined location, and a non-copper foil pattern portion free of the copper foil pattern is provide to be opposed to this copper foil pattern, whereby the outgases generated from the printed circuit board are guided to a peak of the mountain portion, and the guided outgases are easily discharged from the non-copper foil pattern portion in the vicinity of this peak. Thus, by forming the copper foil pattern whose mountain portions and valley portions are continuous and the non-copper foil pattern portion opposed thereto on a pasted copper foil portion which comparatively widely covers a surface of the printed circuit board according to the present invention, conventional problems such that sealed outgases gather on an interface between a substrate base and a copper foil of the printed circuit board due to the fact that the copper foil inhibits the discharge of the outgases, resulting in pushing up and swelling up the copper foil and swelling up further the substrate base beneath the copper foil can be remarkably improved. Further, in the vicinity of terminal holes into which terminals of electronic parts are to be inserted, with respect to a problem that the swell is prone to occur with the printed circuit board due to a thermal load generated when heat with a high temperature is supplied from the inserted terminal and due to a load biased in a spread direction caused by rigidity of the terminal, the swell of the printed circuit board in the vicinity of the terminal hole can be prevented by forming the copper foil pattern and the non-copper foil pattern portion opposed thereto according to the present invention on the copper foil pattern in the vicinity of the terminal hole of the electronic parts in which swell of the printed circuit board may occur. Further, there can be used an inexpensive printed circuit board which is heated at the time of solder immersion, resulting in a high temperature, and which is formed of a paper-substrate phenol resin copper-clad laminate easily generating outgases of alcohol or analogous such as methanol or 1-buthanol contained in the phenol resin, a volatile component such as formaldehyde, or toluene and phenol, and moisture contained in the paper substrate. Thus, the cost of the electronic apparatus can be reduced by using this inexpensive printed circuit board.

According to the second aspect of the present invention, a non-resist portion is provided in the vicinity of the peak of the mountain portion formed and allocated on this printed circuit board, and thus, the vicinity of the peak is not covered with a resist film having heat insulating property and gas permeation retardant property. In addition, this non-resist portion is produced as an exposure portion of a metal by solder immersion of the printed circuit board. Then, the cooling of the vicinity of the peak is accelerated by heat radiation in the vicinity of the peak of the mountain portion and transfer of heat is quickly achieved to the vicinity of the peak of the mountain portion from the valley portion, thereby making it possible to help transfer of outgases and improve discharge property of the outgases. In this manner, the copper foil pattern is quickly cooled, thus making it possible to effectively prevent the swell of the printed circuit board caused by a thermal load and the load or the like biased in the spread direction by the terminal rigidity or the swell of the printed circuit board caused by the outgases.

According to the third aspect of the present invention, a through hole is provided at a peak of the mountain portion formed and allocated on this printed circuit board. Thus, outgases easily move from a depth portion of a substrate base of the printed circuit board to an end of the through hole, and the resultant outgases can be discharged from the end of the through hole. In this manner, the swell of the printed circuit board caused by the outgases can be further efficiently prevented.

According to the fourth aspect of the present invention, a non-copper foil pattern portion opposed to the copper foil pattern formed and allocated on this printed circuit board is produced as a through hole, thus making it possible to widely allocate an end area of the through hole for discharging the outgases from the depth portion of the substrate base of the printed circuit board and to improve outgas discharge effect. In this manner, the swell of the printed circuit board caused by outgases can be further effectively prevented, and thus, the present invention is applicable to a pasted copper foil portion having a wide area.

According to the fifth aspect of the present invention, the copper foil pattern allocated on this printed circuit board forms a mountain portion and a valley portion at the rear side of the printed circuit board in the forward direction at the time of solder immersion, and is allocated in a predetermined location at the rear side of the forward direction. In this manner, efficient heat radiation and cooling are achieved from the vicinity of the peak of the mountain portion in the predetermined location at the rear side of the forward direction at the time of solder immersion in which a high temperature heat of molten solder is prone to be accumulated, resulting in a high temperature, whereby the swell of the printed circuit board is prone to occur. In addition, outgases are efficiently discharged from the non-copper foil pattern portion, through holes and penetrating portion in the vicinity of the peak of the mountain portion, whereby the swell of the printed circuit board can be prevented. Therefore, the copper foil pattern of the invention is formed and allocated at the pasted copper foil portion at the rear side of the forward direction in which a high temperature heat generated at the time of solder immersion is prone to be accumulated, resulting in a high temperature, and the swell of the printed circuit board is prone to occur, or alternatively, this copper foil pattern is allocated on the copper foil pattern in the vicinity of the terminal holes of the electronic parts, thereby making it possible to prevent the swell of the printed circuit board due to these outgases and the swell of the printed circuit board due to the thermal load and terminal rigidity. In this manner, a quality problem that a copper foil pattern is peeled off and breakage with an elapse of time occurs is prevented in advance, thereby making it possible to improve long-term reliability of the electronic apparatus.

### BRIEF DESCRIPTION OF THE DRAWINGS

FIG. 1 is an illustrative plan view showing a copper foil pattern whose mountain portions and valley portions are continuous and a non-copper foil pattern portion opposed thereto in a first embodiment of the present invention;

FIG. 2 is an illustrative sectional view showing a copper foil pattern and a non-copper foil pattern portion opposed thereto in the present invention;

FIG. 3 is an illustrative plan view showing a non-resist portion formed in the vicinity of a peak of a mountain portion and a non-copper foil pattern portion opposed to this copper foil pattern in a second embodiment of the present invention;

FIG. 4 is an illustrative sectional view showing a non-resist portion formed in the vicinity of a peak of a mountain portion and a non-copper foil pattern portion opposed to this copper foil pattern in the present invention;

FIG. 5 is an illustrative plan view showing a through hole formed at a peak of a mountain portion and a non-copper foil pattern portion opposed to this copper foil pattern in a third embodiment of the present invention;

FIG. 6 is an illustrative sectional view showing a through hole formed at a peak of a mountain portion and a non-copper foil pattern portion opposed to this copper foil pattern in the present invention;

FIG. 7 is an illustrative plan view showing a copper foil pattern and a penetrating portion opposed thereto in a fourth embodiment of the present invention;

FIG. 8 is an illustrative sectional view showing a copper foil pattern and a penetrating portion opposed thereto in the present invention;

FIG. 9 is an illustrative plan view showing a penetrating portion and a copper foil pattern having continuous mountain portions and valley portions formed on both sides while the penetrating portion is sandwiched therebetween, in a fifth embodiment of the present invention;

FIG. 10 is an illustrative sectional view showing a penetrating portion and a copper foil pattern formed on both sides while the penetrating portion is sandwiched therebetween, in the present invention;

FIG. 11 is an illustrative plan view showing a copper foil pattern formed on a main circuit board of a DVD device in a sixth embodiment of the present invention;

FIG. 12 is a perspective illustration showing an appearance of the inside of a DVD device having allocated therein a main circuit board on which the copper foil pattern in the present invention has been formed;

FIG. 13 is an illustrative view showing an overview of an immersion technique using molten solder; and

FIG. 14 is an illustrative sectional view showing a swell of a copper foil or a swell of a substrate conventionally generated on a printed circuit board.

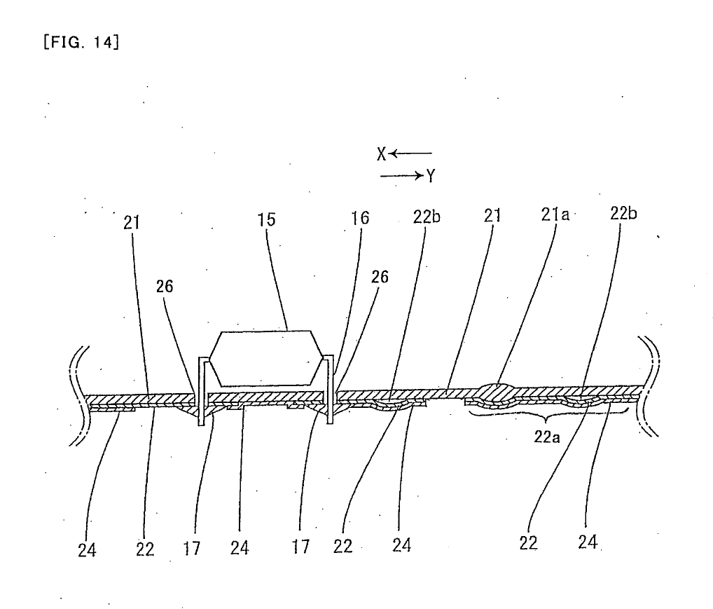

### DESCRIPTION OF THE PREFERRED EMBODIMENTS

As described above, the present invention is featured by a printed circuit board to be soldered by a molten solder immersion technique in which a swell on the printed circuit board caused by outgases generated from a substrate of the printed circuit board is prevented. In the following description of embodiments, a first embodiment describes that a copper foil pattern whose mountain portions and valley portions are continuous and a non-copper foil portion opposed thereto have been formed; a second embodiment describes that a non-resist portion has been provided in the vicinity of a peak of the mountain portion of the first embodiment; and a third embodiment describes that a through hole has been provided at a peak of the mountain portion of the first embodiment. A fourth embodiment describes that a non-copper foil portion has been produced as a penetrating portion in the first embodiment, and a fifth embodiment describes that these copper foil patterns are allocated on a main circuit board of a DVD device.

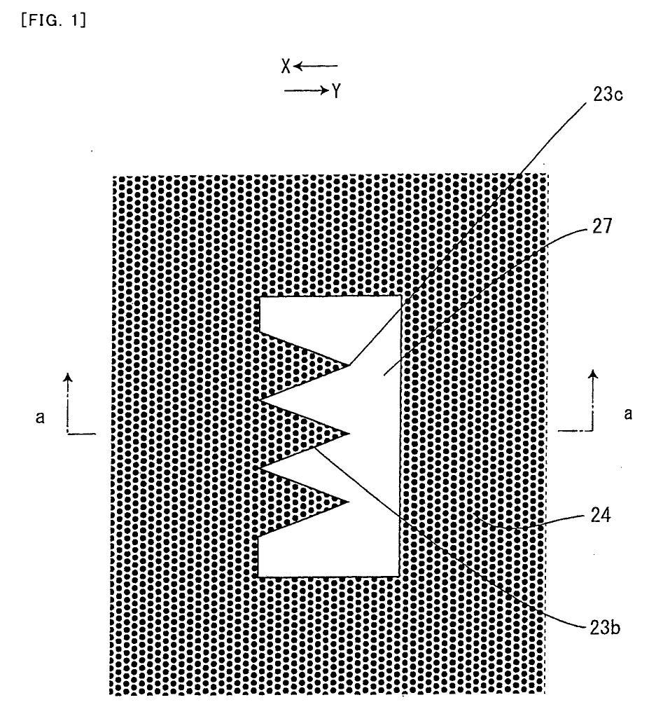

Hereinafter, embodiments serving as the best mode for carrying out the present invention are described with reference to FIGS. 1 to 13. Of course, the present invention can be easily applied to the embodiments other than those described herein without departing from the spirit of the invention.

### First Embodiment

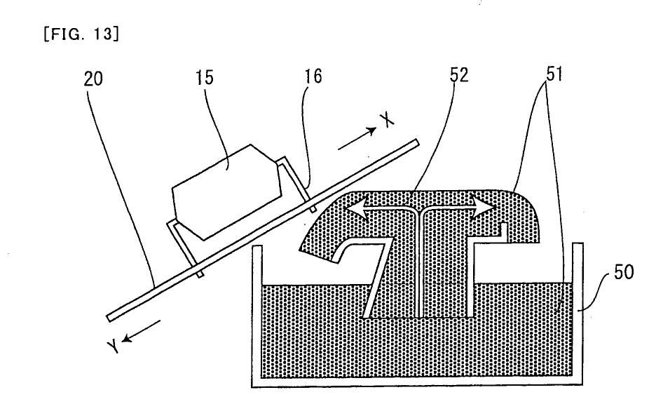

First, referring to FIG. 13, a description will be given with respect to a relationship between molten solder applied when soldering is carried out in accordance with a molten solder immersion technique and a printed circuit board on which electronic parts have been mounted. In FIG. 13, molten solder 51 heated by a heater, although not shown, is discharged upwardly in a discharge type solder vessel 50, as shown in a flow direction 52 of the molten solder 51 by means of a pump, although not shown. In the meantime, terminals 16 of electronic parts 15 are inserted and mounted in terminal holes, although not shown, of a printed circuit board 20. This printed circuit board 20 moves in an X direction, and is soldered while it sequentially comes into contact with the discharged molten solder 51. In this case, Y indicates a rear side of the printed circuit board 20 in a forward direction. When the printed circuit board 20 thus comes into contact with the molten solder 51, the X side of the printed circuit board 20 in the forward direction comes into contact with the molten solder 51, and is heated by the molten solder 51, resulting in a temperature rise. However, at the rear side Y of the printed circuit board 20 in the forward direction, a temperature increases in advance due to heat conduction from the X side of the printed circuit board 20 in the forward direction, and then, the rear side Y comes into contact with the molten solder 51, whereby the rear side Y of the printed circuit board 20 in the forward direction is prone to be hotter than expected. Therefore, the generation of outgases increases, whereby the printed circuit board 20 is prone to swell.

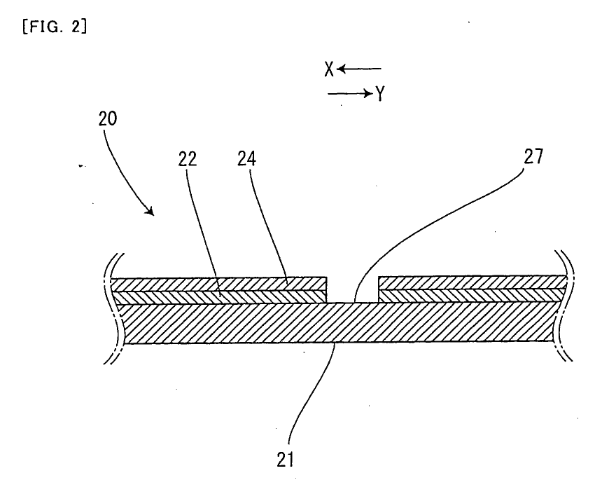

FIG. 1 is a plan view of a copper foil pattern whose mountain portions and valley portions are continuous and a non-copper foil pattern portion opposed thereto showing the first embodiment of the present invention, and FIG. 2 is a sectional view taken along the line a-a of FIG. 1.

X shown in FIGS. 1 and 2 denotes a forward direction of the printed circuit board 20 when soldering is carried out in accordance with the molten solder immersion technique described previously, and Y denotes a rear side of the forward direction. In addition, this printed circuit board 20 consists of a paper-substrate phenol resin copper-clad laminate. This material for the printed circuit board 20 is often used as an inexpensive material and has a problem that the material is heated at the time of solder immersion, resulting in a high temperature, and outgases including alcohol or the like such as methanol or 1-buthanol contained in the phenol resin, a volatile component such as formaldehyde, toluene and phenol, or moisture contained in the paper substrate are prone to be generated. In FIG. 1, reference numeral 24 denotes a resist film 24 covering a surface of a copper foil 22 shown in FIG. 2. In addition, a region covered with this resist film 24 is produced as a pasted copper foil portion which comparatively widely covers a surface of the printed circuit board 20, and is produced as a region in which outgases are unlikely to be discharged. Here, a copper foil pattern 23, having continuous mounting portions and valley portions of a sawtooth shape 23b with a sharpen peak 23c, is formed so as to be substantially orthogonal to the forward direction X at the time of solder immersion. A non-copper foil pattern portion 27 is provided to be opposed to this copper foil pattern 23.

Reference numeral 21 shown in FIG. 2 denotes a substrate base 21 of the printed circuit board 20 and consists of a paper substrate phenol resin. On its surface, a copper foil 22 forms a wiring circuit, and further, its surface is coated with the resist film 24. The non-copper foil pattern portion 27 is provided so as to come into contact with an end edge of the copper foil pattern 23 of this sawtooth shape 23b.

According to the first embodiment described above, this printed circuit board 20 formed of a paper-substrate phenol resin copper-clad laminate is heated at the time of solder immersion, resulting in a high temperature, and there are generated outgases including alcohol or the like such as methanol or 1-buthanol contained in the phenol resin, a volatile component such as formaldehyde, toluene and phenol, or moisture contained in the paper substrate. In the meantime, there is formed the copper foil pattern 23 of the sawtooth shape 23b with the sharp peak 23c which is substantially orthogonal to the forward direction X of the printed circuit board 20 at the time of solder immersion, and the no-copper foil pattern portion 27 free of a copper foil is provided to be opposed to this copper foil pattern 23. In this manner, the sharpened peak 23c of the copper foil pattern 23 is quickly cooled, and thus, a temperature gradient is generated toward the sharpened peak 23c, and heat is transferred at the time of solder immersion. Due to this heat transfer, the outgases generated from the printed circuit board 20 using the paper substrate and phenol resin as a base are guided to the peak 23c of the mountain portion of the copper foil pattern 23, and the guided outgases are discharged from the non-copper foil pattern portion 27 in the vicinity of this peak 23c.

### Second Embodiment

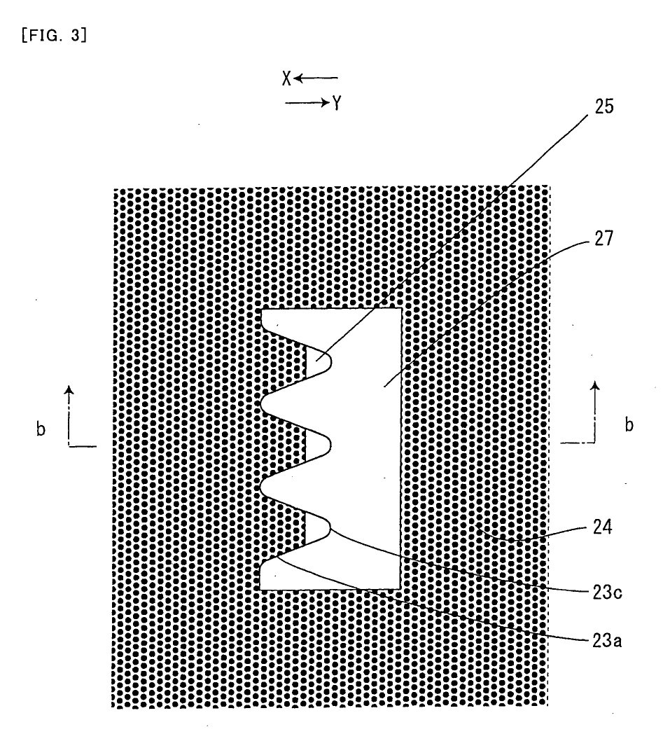

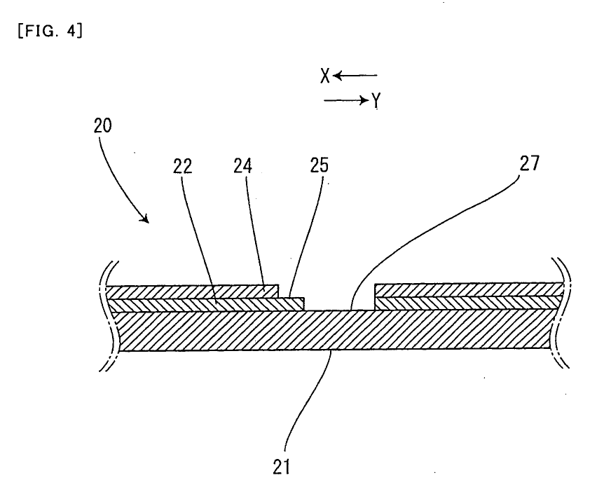

Now, a second embodiment in the present invention will be described with reference to FIGS. 3 and 4. While the second embodiment is basically identical to the first embodiment, the present embodiment is featured in that the shape of a copper foil pattern 23 is slightly different, and a resist film 24 is not provided in the vicinity of a peak. FIG. 3 is a plan view showing a case where a non-resist portion is formed in the vicinity of a peak of a mountain portion of a copper foil pattern 23, and a non-copper foil pattern portion 27 is formed to be opposed thereto. FIG. 4 is a sectional view taken along the line b-b of FIG. 3.

A copper foil pattern 23 shown in FIG. 3 is formed of a wave shape 23a with round mountain portions and valley portions, and a non-resist portion 25 is provided in the vicinity of this peak 23c. In addition, a non-copper foil pattern portion 27 is provided to be opposed to the copper foil pattern 23.

Now, a sectional structure of this printed circuit board 20 will be described with reference to FIG. 4. A copper foil 22 forms a wiring circuit on a surface of a substrate base 21, and further, its surface is covered with a resist film 24. A non-resist portion 25 free of the resist film 24 is produced in the vicinity of the peak 23c. A non-copper foil pattern portion 27 is provided so as to come into contact with this copper foil pattern 23.

In accordance with the second embodiment described above, on this printed circuit board 20, the copper foil pattern 23 with the round peak 23c is formed so as to be substantially orthogonal to a forward direction X of the printed circuit board 20 at the time of solder immersion; and the non-copper foil pattern portion 27 free of the copper foil 22 is provided to be opposed to this copper foil pattern 23. In addition, the non-resist portion 25 free of the resist film 24 is produced in the vicinity of this peak 23c, and the peak 23c is narrowly formed of the wave shape 23a. The non-resist portion 25 is in the vicinity of this peak 23c, which is not covered with the resist film 24 having heat insulating property and gas permeation retardant property. This non-resist portion 25 is soldered by means of solder immersion of the printed circuit board 20, and is produced as an exposure portion of a metal of solder 17. The cooling in the vicinity of the peak 23c is accelerated by heat radiation at the non-resist portion 25 in the vicinity of the peak 23c of the copper foil pattern 23 and heat transfer is quickly carried out in the vicinity of the peak 23c from the valley portion of the copper foil pattern 23, making it possible to help outgas transfer and improve outgas discharge property. In this manner, this copper foil pattern 23 is quickly cooled, thus making it possible to effectively prevent the swell of the printed circuit board 20 caused by a thermal load and a load or the like biased in a spread direction caused by the rigidity of the terminal 16 or the swell of the printed circuit board 20 caused by outgases.

### Third Embodiment

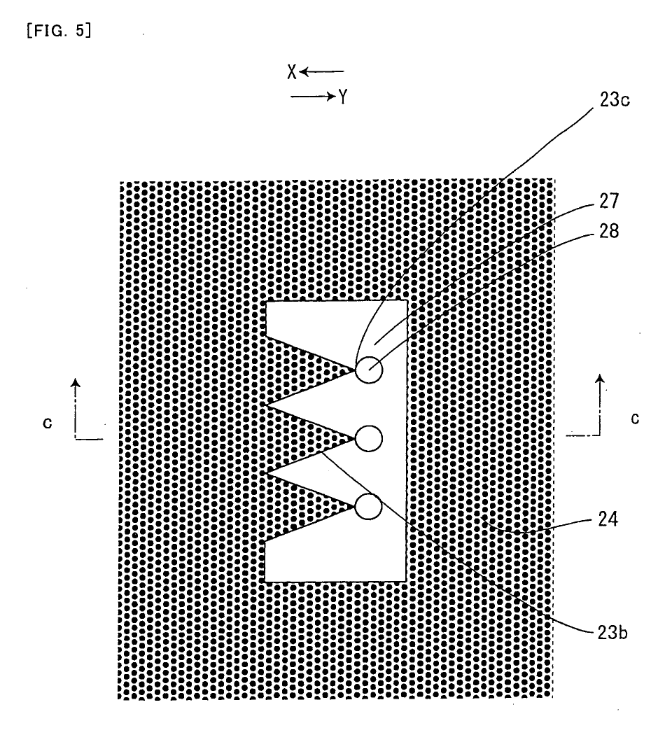

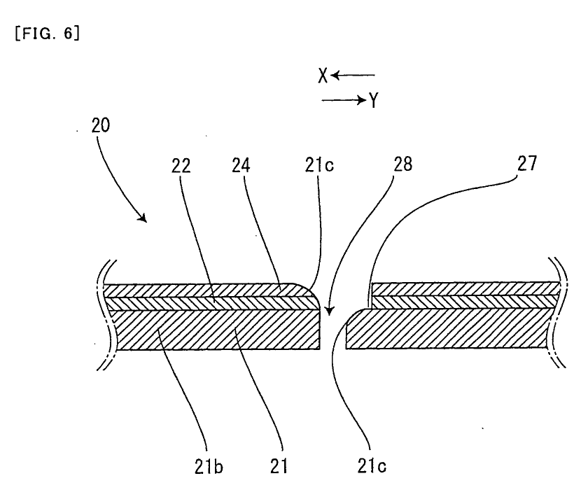

Now, a third embodiment in the present invention will be described with reference to FIGS. 5 and 6. While the third embodiment is basically identical to the first embodiment, the present embodiment is featured in that a through hole is provided at a peak of a mountain portion. FIG. 5 is a plan view showing a case where a through hole is formed at a peak of a copper foil pattern 23 formed in a sawtooth shape 23b, and a non-copper foil pattern portion 27 is formed to be opposed thereto. FIG. 6 is a sectional view taken along the line c-c of FIG. 5.

A circular through hole 28 is provided at a peak 23c of a mountain portion of a copper foil pattern 23 formed in a sawtooth shape 23b shown in FIG. 5. In addition, a non-copper foil pattern portion 27 is provided to be opposed to the copper foil pattern 23.

Now, a sectional structure of this printed circuit board 20 will be described with reference to FIG. 6. A copper foil 22 forms a wiring circuit on a surface of a substrate base 21, and further, its surface is covered with a resist film 24. At the peak 23c of a mountain portion of the copper foil pattern 23, a though hole 28 is provided to form a taper 21c having a wide opening at a side at which this copper foil pattern 23 is formed. In addition, the non-copper foil pattern portion 27 is provided so as to come into contact with this copper foil pattern 23.

In accordance with the third embodiment described above, on this printed circuit board 20, the through hole 28 is provided at the peak 23c of the mountain portion, and thus, outgases easily move from a depth portion 21b of the substrate base 21 of the printed circuit board 20 to an end of the through hole 28, and can be discharged. Further, this through hole 28 forms the taper 21c, and is formed to have a wide opening at a side at which the copper foil pattern 23 has been formed. This prevents the molten solder from closing the through hole 28 and also prevents the copper foil 22 serving as the peak 23c formed in the sawtooth shape 23b from being wound, thereby stabilizing outgas discharge in the vicinity of the peak 23c. Thus, the swell of the printed circuit board 20 caused by outgases can be effectively prevented.

### Fourth Embodiment

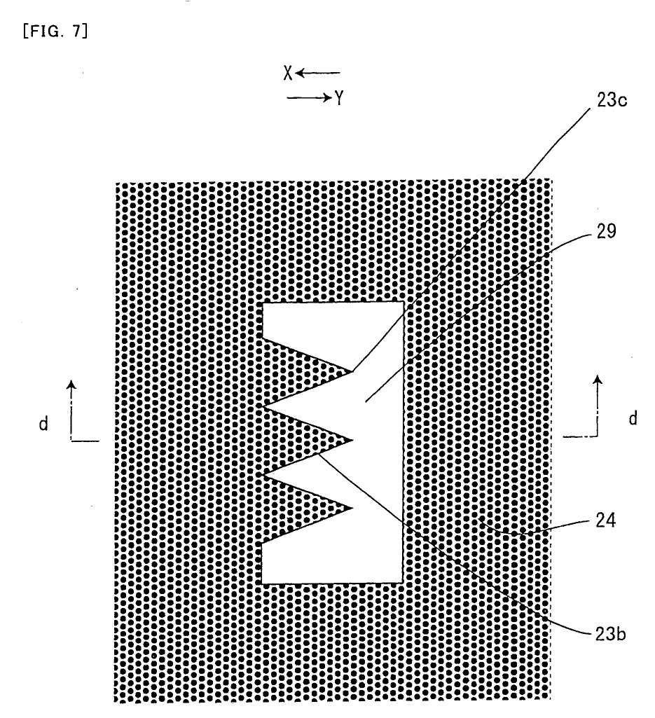

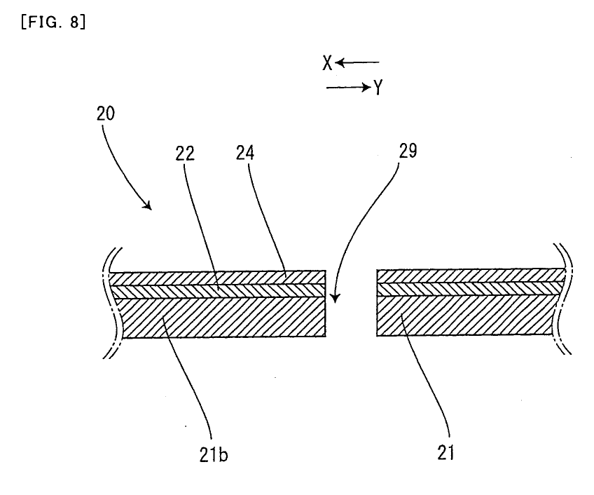

Now, a fourth embodiment in the present invention will be described here. The fourth embodiment is basically identical to the first embodiment, and the present embodiment is featured in that a non-copper foil pattern portion 27 opposed to a copper foil pattern 23 is produced as a penetrating portion. FIG. 7 is a plan view showing a case where a penetrating portion has been formed to be opposed to a copper foil pattern 23 formed in a sawtooth shape 23b, and FIG. 8 is a sectional view taken along the line d-d of FIG. 7.

On a copper foil pattern 23 formed in a sawtooth shape 23b shown in FIG. 7, a penetrating portion 29 is provided to be opposed thereto, and an end of the penetrating portion 29 is formed to be elongated all over the periphery of a non-copper foil pattern portion 27 adjacent to the copper foil pattern 23.

Now, a sectional structure of this printed circuit board 20 will be described with reference to FIG. 8. A copper foil 22 forms a wiring circuit on a surface of a substrate base 21, and further, its surface is covered with a resist film 24. The penetrating portion 29 is provided on this printed circuit board 20, and the substrate base 21, the copper foil 22, and the resist film 24 form an end all over the periphery of the penetrating portion 29.

As has been described above, according to the fourth embodiment, the non-copper foil pattern portion 27 opposed to the copper foil pattern 23 formed and allocated on this printed circuit board 20 is produced as the penetrating portion 29, thus making it possible to widely allocate an end area of the through hole 28 in the third embodiment, for discharging outgases from a depth portion 21b of the substrate base 21 of the printed circuit board 20. Thus, the discharge property of outgases can be significantly improved. In this manner, the swell of the printed circuit board 20 caused by outgases can be further effectively prevented, and thus, the present invention can be applied to a pasted copper foil portion having a wide area (not shown).

### Fifth Embodiment

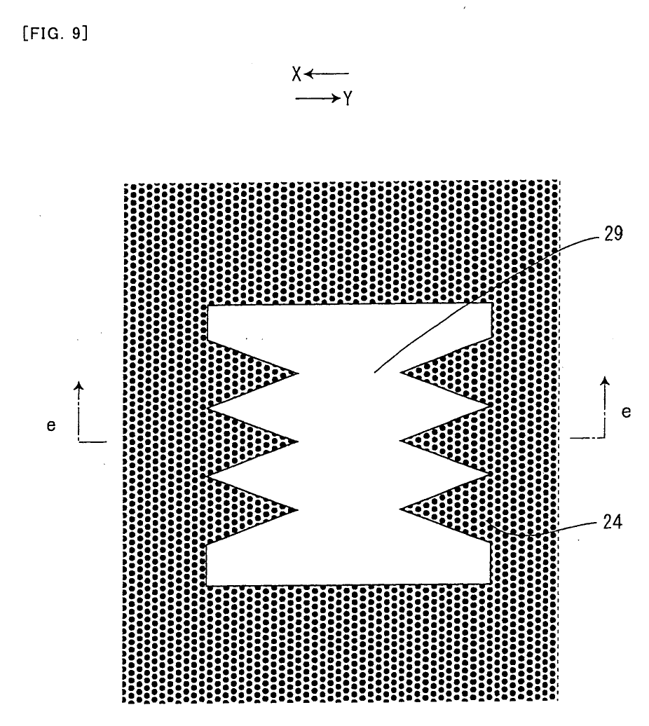

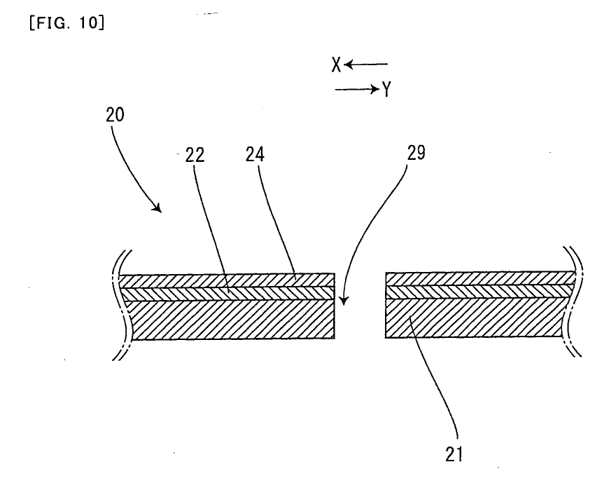

Now, a fifth embodiment in the present invention will be described here. The fifth embodiment is basically identical to the first embodiment, and the present embodiment is featured in that a sawtooth shaped copper foil pattern 23b is formed on both sides of a non-copper foil pattern portion 27 provided to be opposed to a copper foil pattern 23, and further, this non-copper foil pattern portion 27 is provided as a penetrating portion 29. FIG. 9 is a plan view of a penetrating portion 29 showing a case where a sawtooth shaped copper foil pattern 23b has been formed on both sides, and FIG. 10 is a sectional view taken along the line e-e of FIG. 9.

On a copper foil pattern 23 formed in a sawtooth shape 23b shown in FIG. 9, a penetrating portion 29 is provided to be opposed thereto, and the copper foil pattern 23 formed in the sawtooth shape 23b is further provided to be opposed to this penetrating portion 29. An end of the penetrating portion 29 is formed to be elongated all over the periphery thereof.

Now, a sectional structure of this printed circuit board 20 will be described with reference to FIG. 10. A copper foil 22 forms a wiring circuit on a surface of a substrate base 21, and further, its surface is covered with a resist film 24. The penetrating portion 29 is provided on this printed circuit board 20, and the substrate base 21, the copper foil 22, and the resist film 24 form an end all over the periphery of the penetrating portion 29.

As has been described above, according to the fifth embodiment, a non-copper foil pattern portion 27 opposed to the copper foil pattern 23 formed and allocated on this printed circuit board 20 is produced as the penetrating portion 29, and further, the copper foil pattern 23 is formed in the sawtooth shape 23b to be opposed to this penetrating portion 29. Thus, outgases on the both sides of the penetrating portion 29 can be discharged from a depth portion 21b of the substrate base 21 of the printed circuit board 20 by means of the copper foil pattern 23 formed on both sides of this penetrating portion 29. When this pattern is allocated at a substantially central part of a pasted copper foil portion having a wide area (not shown), the discharge effect of outgases in the wide area can be remarkably improved. In this manner, at the pasted copper foil portion having a wide area, the swell of the printed circuit board 20 caused by outgases can be further effectively prevented.

### Sixth Embodiment

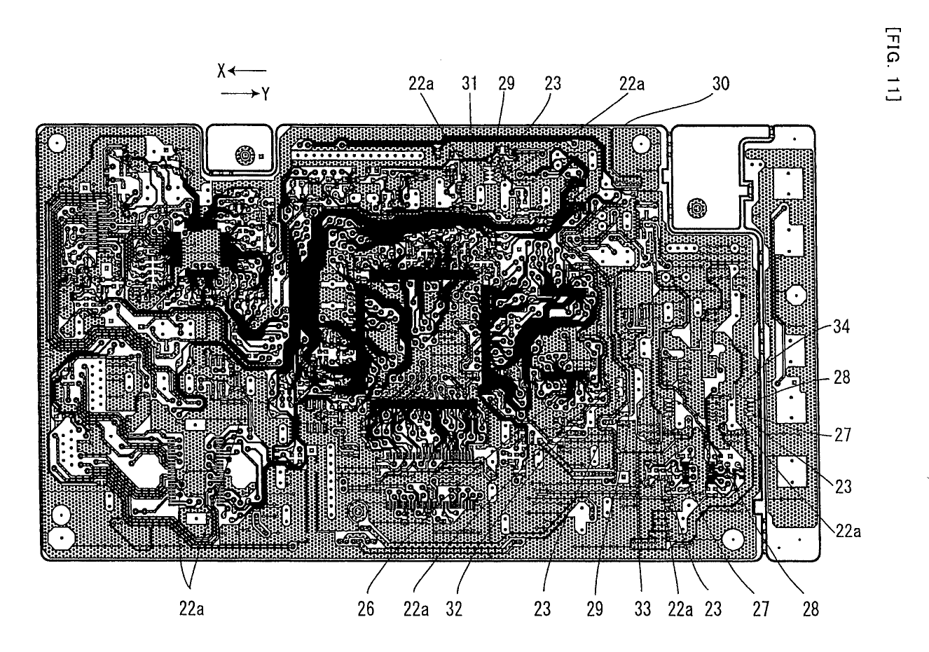

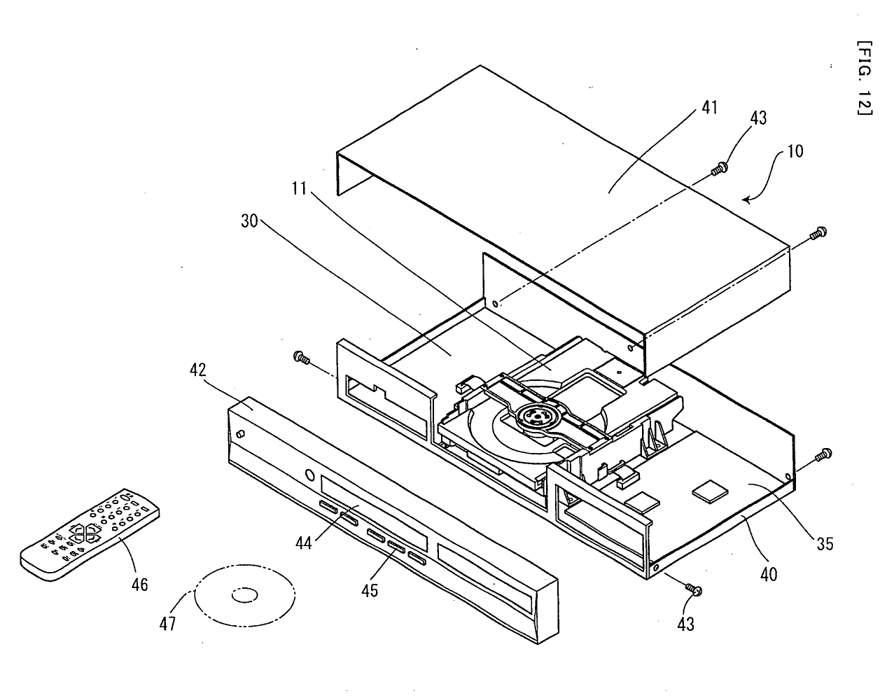

Now, a sixth embodiment in the present invention will be described here. In the sixth embodiment, a plurality of types of copper foil patterns 23 described previously are formed and allocated on a first substrate configuring a main circuit board of a DVD device. In the present embodiment, FIG. 11 is a plan view showing a main circuit board of a DVD device having allocated therein a copper foil pattern 23 whose mountain portions and valley portions are continuous. FIG. 12 is a perspective view showing an internal view of the DVD device having allocated thereon this main circuit board.

Reference numeral 30 shown in FIG. 11 denotes a first substrate configuring a main circuit board of a DVD device shown in FIG. 12, wherein a power circuit for supplying power to the inside of a DVD device 10 and an analog system circuit such as a video image and voice processor circuit to process a video image and voice signal received via a tuner or a reproduced video image and voice signal in a displayable manner are formed and allocated thereto. In addition, while a plurality of pasted copper foil portions 22a are formed and allocated on this first substrate 30, first to fourth copper foil patterns 31, 32, 33, and 34 are formed and allocated to be substantially orthogonal to a forward direction X of the printed circuit board 20 respectively at locations serving as the pasted copper foil portions 22a whose wide area is occupied by a copper foil 22 in areas serving as rear sides Y of the forward direction at the time of solder immersion. The first copper foil pattern 31 is featured in that a copper foil pattern 23 whose mountain portions and valley portions are continuous is formed on both sides of the penetrating portion 29 according to the fifth embodiment described previously. In addition, the second copper foil pattern 32 is featured in that a penetrating portion 29 is formed to be opposed to the copper foil pattern 23 according to the fourth embodiment. The third and fourth copper foil patterns 33 and 34 are featured in that a copper foil pattern 23 in which a through hole 28 has been formed is formed in the vicinity of the peak 23c according to the third embodiment described previously.

The first copper foil pattern 31 is allocated at a pasted copper foil portion 22a which covers a comparatively wide area of a surface of the printed circuit board 20 in an X/Y direction, accordingly a pattern shape applicable in a wide area according to the fifth embodiment is selected thereto. In the meantime, the second copper foil pattern 32 is allocated at a location where the width of the copper foil 22 is relatively narrow, the location different from that of a pasted copper foil portion 22a covering a comparatively wide area of a surface of the printed circuit board 20, however terminal holes 26 in which electronic parts 15 are mounted are allocated in the vicinity of the second copper foil pattern 32, where a swell portion 22b of the copper foil 22 is prone to occur, accordingly a pattern shape having a penetrating portion 29 according to the fourth embodiment is selected. In addition, each of the third and fourth copper foil patterns 33 and 34 is allocated at a pasted copper foil portion 22a which covers a comparatively wide area, accordingly a pattern shape having a through hole 28 according to the third embodiment is selected.

Now, referring to FIG. 12, a description will be given with respect to an internal view of the DVD device 10 in which this first substrate 30 has been allocated. In FIG. 12, this DVD device 10 has a cabinet formed of a chassis 40 and a cover 41 configuring a back cabinet, and a front cabinet 42. Each of the cabinets are mounted and fixed with screws 43. A DVD unit 11 is allocated at a substantially central part of this chassis 40. At the left side thereof, a first substrate 30 on which an analog system circuit configuring a main circuit board of the DVD device 10 according to the present embodiment is formed is allocated. At the right side thereof, similarly, a second substrate on which a digital system circuit configuring a main circuit board of the DVD device 10 is formed is allocated. In addition, a mount and demount portion 44 of a DVD disk 47 and operating switches 45 or the like are allocated at the front cabinet 42, wherein a remote controller transmitter 46 is operated, thereby making it possible to achieve recording and reproducing operation by means of this DVD device 10.

As has been described above, according to the sixth embodiment, on the first substrate 30 having formed thereon an analog system circuit configuring the main circuit board of the DVD device 10, pasted copper foil portions 22a each having a wide area of a copper foil 22 are allocated in plural locations. Copper foil patterns 23 formed and allocated at the pasted copper foil portions 22a form mountain portions and valley portions which are continuous at the rear side Y of the printed circuit board 20 in the forward direction at the time of solder immersion, and are allocated in predetermined locations at the rear side Y of the forward direction, whereby a heat of molten solder is easily accumulated, resulting in a high temperature. Thus, efficient heat radiation and cooling are achieved from the vicinity of the peak 23c of the mountain portion in predetermined location at the rear side Y of the forward direction at the time of solder immersion in which the swell of the printed circuit board 20 easily occurs. In addition, outgases are efficiently discharged from the non-copper foil pattern portion 27, the through hole 28, and the penetrating portion 29 in the vicinity of the peak 23c of the mountain portion. In this manner, the swell of the first substrate 30 can be prevented. Therefore, the copper foil pattern 23 according to the present invention is formed and allocated at the pasted copper foil portion 22a at the rear side Y of the forward direction in which a high temperature heat at the time of solder immersion is prone to be accumulated, resulting in a high temperature, and the swell of the first substrate 30 is prone to occur. Alternatively, this copper foil pattern 23 is allocated in the vicinity of terminal holes 26 for the electronic parts 15, thereby making it possible to prevent the swell of the first substrate 30 due to these outgases and the swell of the first substrate 30 due to a thermal load and the rigidity of terminals 16. In this manner, a quality problem that the copper foil 22 is peeled off, and breakage with an elapse of time occurs is prevented in advance, thereby making it possible to improve long-term reliability of the DVD device 10.

A detailed description of the present embodiment has now been completed. However, various modifications can occur without departing from the spirit of the present invention. For example, the shape of the copper foil pattern 23 is not limited to the copper foil pattern 23 having the continuous mountain portions and valley portions as long as the outgas discharge property is improved by heat radiation property such as a substantially short piece shape. In addition, a combination of the shape of the copper foil pattern 23 such as a sawtooth shape 23b or a wave shape 23a, a non-copper foil pattern portion 27 and non-resist portion 25, and a through hole 28 and a penetrating portion 29 may be properly selected by setting it in consideration of outgas discharge property of a location for allocating a copper foil pattern 23.

1. An electronic apparatus including a printed circuit board which forms an electric circuit by soldering electronic parts in accordance with a molten solder immersion technique, wherein
the printed circuit board consists of a paper-substrate phenol resin copper-clad laminate,
a copper foil pattern whose mountain portions and valley portions are continuous is formed and allocated in predetermined location on the printed circuit board so as to be substantially orthogonal to a forward direction at the time of solder immersion thereof, and
a non-copper foil pattern portion is provided to be opposed to the copper foil pattern.

2. The electronic apparatus including a printed circuit board according to claim 1, wherein a non-resist portion is provided in the vicinity of a peak of the mountain portion.

3. The electronic apparatus including a printed circuit board according to claim 1, wherein a through hole is provided at the peak of the mountain portion.

4. The electronic apparatus including a printed circuit board according to claim 1, wherein the non-copper foil pattern portion is a penetrating portion.

5. The electronic apparatus including a printed circuit board according to claim 1, wherein the copper foil pattern is allocated in a predetermined location at a rear side of a printed circuit board in a forward direction at the time of solder immersion and a non-copper foil pattern portion is formed behind the copper foil pattern in the forward direction to be opposed to the copper foil pattern.

6. The electronic apparatus including a printed circuit board according to claim 2, wherein a through hole is provided at the peak of the mountain portion.

7. The electronic apparatus including a printed circuit board according to claim 2, wherein the non-copper foil pattern portion is a penetrating portion.

8. The electronic apparatus including a printed circuit board according to claim 2, wherein the copper foil pattern is allocated in a predetermined location at a rear side of a printed circuit board in a forward direction at the time of solder immersion and a non-copper foil pattern portion is formed behind the copper foil pattern in the forward direction to be opposed to the copper foil pattern.

9. The electronic apparatus including a printed circuit board according to claim 3, wherein the copper foil pattern is allocated in a predetermined location at a rear side of a printed circuit board in a forward direction at the time of solder immersion and a non-copper foil pattern portion is formed behind the copper foil pattern in the forward direction to be opposed to the copper foil pattern.

10. The electronic apparatus including a printed circuit board according to claim 6, wherein the copper foil pattern is allocated in a predetermined location at a rear side of a printed circuit board in a forward direction at the time of solder immersion and a non-copper foil pattern portion is formed behind the copper foil pattern in the forward direction to be opposed to the copper foil pattern.

11. The electronic apparatus including a printed circuit board according to claim 4, wherein the copper foil pattern is allocated in a predetermined location at a rear side of a printed circuit board in a forward direction at the time of solder immersion and a non-copper foil pattern portion is formed behind the copper foil pattern in the forward direction to be opposed to the copper foil pattern.

12. The electronic apparatus including a printed circuit board according to claim 7, wherein the copper foil pattern is allocated in a predetermined location at a rear side of a printed circuit board in a forward direction at the time of solder immersion and a non-copper foil pattern portion is formed behind the copper foil pattern in the forward direction to be opposed to the copper foil pattern.
